(19) United States
(12) Patent Application Publication
(10) Pub. No.: US 2008/0026114 A1
(43) Pub. Date: Jan. 31, 2008

(54) Microwavable food products and methods

(76) Inventors: Tom Johnson, Morganton, NC (US); Julie D. Johnson, Morganton, NC (US)

Correspondence Address: KILPATRICK STOCKTON LLP, 1001 WEST FOURTH STREET, WINSTON-SALEM, NC, 27101, US

(21) Appl. No.: 11/881,297

(22) Filed: Jul. 26, 2007

Related U.S. Application Data
(60) Provisional application No. 60/833,720, filed on Jul. 27, 2006.

(51) Int. Cl. B65B 25/22; A23L 1/00

(52) U.S. Cl. 426/114; 426/106; 426/124; 426/128; 426/392; 426/394

(57) ABSTRACT

A microwavable product can include a first food product in a package, and a flow-capable butter-syrup compound in the package adapted to remain solid prior to heating. The butter-syrup compound may be packaged in direct contact with the first food product. The butter-syrup compound can include substantially pure butter and/or substantially all natural syrup. The butter-syrup compound can include about 50% butter and about 50% maple syrup, and can be a homogenous mixture of butter and syrup components.

### CROSS-REFERENCE TO RELATED APPLICATIONS

This application claims priority to co-pending U.S. Provisional Patent Application No. 60/833,720, filed Jul. 27, 2006, which is incorporated by reference herein in its entirety.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates to microwavable food products and methods for making, packaging, and using such a food product.

### BACKGROUND OF THE INVENTION

Food products are often prepared and packaged for heating in a microwave oven. Microwavable food products may be packaged in individual serving sizes, which can facilitate the convenience of quickly heating and eating the food products. For certain foods products, it may be desirable to include a sauce, topping, condiment, or another food in the package for consumption with the other food product. For example, some pre-packaged, microwavable entrees that include a meat component may include a sauce, such as a tomato sauce, on the meat. When the package is heated in a microwave oven, the tomato sauce is heated, becomes somewhat liquid, and spreads over the meat. During preparation and packaging of such a microwavable meat product, it may be desirable that the sauce be allowed to penetrate the meat to a degree to infuse the meat with the sauce flavor.

However, for certain food products, it may be desirable that a sauce or topping not be allowed to penetrate the food product during preparation or packaging, because such penetration may impart undesirable characteristics to the food product. For example, microwavable food products, such as pancakes, can be pre-cooked and packaged for later re-heating by a consumer. If a fluid, or flowable, topping, such as a syrup topping, is placed in contact with the pancakes prior to cooking, or after cooking during the packaging process prior to freezing, the syrup can adversely change the texture and edibility of the pancakes when they are later re-heated. As a consequence, conventional microwavable pancake products may not be provided with a syrup topping, leaving the consumer with the inconvenience of separately obtaining a syrup topping if desired. Alternatively, a syrup topping can be packaged separately from the pancakes for either adding to the pancakes prior to heating, or adding after heating the pancakes. This approach requires that the consumer take the extra step of adding a topping to the pancake product.

Conventional microwavable pancake-type products that include a separately packaged syrup topping often include only the syrup itself. If a consumer desires to include butter with the syrup topping, the consumer has the inconvenience of obtaining the butter separately. Another disadvantage of syrup toppings provided with conventional microwavable pancake-type products is that those toppings often comprise large amounts of artificial, or imitation, flavorings. For example, such syrup toppings may include butter flavoring, rather than real butter, and/or maple flavoring, rather than pure maple syrup. Such high concentrations of imitation flavorings can detract from the flavor profile of the syrup topping itself, as well as cause the food product to taste artificial.

There is a need for a microwavable pancake-type product having the convenience of a topping packaged directly, in contact, with the food product. There is a need for a microwavable food product having a topping packaged directly with the food product that does not penetrate the food product prior to heating. There is also a need for a microwavable food product packaged with a syrup topping that includes pure butter and syrup ingredients.

### SUMMARY OF THE INVENTION

The present invention can provide embodiments of a product comprising a first food product in a package, and a second food product, or topping, in the package comprising a flow-capable butter-syrup compound adapted to remain solid prior to heating. Each of the food product and the topping can be microwavable. The food product may be, for example, pre-cooked pancakes or waffles, and can have various flavor profiles, textures, and/or configurations. The butter-syrup compound can comprise a mixture, or compound, of a butter component and a non-butter component. The non-butter component can be maple syrup, for example. In certain embodiments, a butter-syrup compound can comprise about 50% butter and about 50% maple syrup. The butter component can be pure, or substantially pure, fresh butter, and the syrup component can be all natural, or substantially all natural, syrup. The butter-syrup compound can be in the form of a molded “pat” or another suitable configuration. The butter-syrup compound can be packaged in direct contact with the food product. In some embodiments, the butter-syrup compound can remain solid until heated. In certain embodiments, the butter-syrup compound can be adapted to remain on the surface of the food product so as to not penetrate into the food product prior to heating. The package may be constructed so as to contain the food products, including the butter-syrup mixture after it is melted, and to allow a consumer to eat the food product and butter-syrup mixture directly from the package.

The present invention can provide embodiments of a method comprising packaging a first food product in a package, and packaging a second food product in the package, the second food product comprising a flow-capable butter-syrup compound adapted to remain solid prior to heating.

Features of microwavable food products and methods of the present invention may be accomplished singularly, or in combination, in one or more of the embodiments of the present invention. As will be appreciated by those of ordinary skill in the art, the present invention has wide utility in a number of applications as illustrated by the variety of features and advantages discussed below.

A microwavable food product and method of the present invention can provide numerous advantages over conventional microwavable food products. For example, the present invention can advantageously provide a microwavable food product having the convenience of a flow-capable topping packaged directly in contact with the food product.

Another advantage is that some embodiments of the present invention can provide a microwavable food product having a flow-capable topping packaged in direct contact with the food product that does not penetrate into the food product prior to heating.

Another advantage is that some embodiments of the present invention can provide a microwavable food product packaged with a syrup topping that includes pure, or substantially pure butter and substantially pure syrup ingredients.

Another advantage is that some embodiments of the present invention can provide a microwavable food product packaged with a flow-capable topping that can be consumed directly from the package after heating.

As will be realized by those of skill in the art, many different embodiments of a microwavable food product and method according to the present invention are possible. Additional uses, objects, advantages, and novel features of the invention are set forth in the detailed description that follows and will become more apparent to those skilled in the art upon examination of the following or by practice of the invention.

### BRIEF DESCRIPTION OF THE DRAWINGS

FIG. 1 is a front partial view of a package having its front flap folded downward to reveal a stack of two pancakes and a pat of butter-syrup mix in an embodiment of the present invention.

FIG. 2 is a plan view of an unfolded package blank useful in an embodiment of the present invention.

### DETAILED DESCRIPTION

The present invention can provide embodiments of a combination of a food product 10 and a flow-capable topping 20, such as a butter-based topping, in a package. Each of the food product 10 and the flow-capable topping 20 can be microwavable. As used herein, a “microwavable” food product means that the food product can be heated for consumption using microwaves in a short period of time without the container of the food product being heated. As used herein, “food product” may refer to an edible material for human or animal consumption, for example, a griddle-type food product such as pancakes, a butter-syrup mix, and/or any other foods or edible ingredients in a package 30 as described herein.

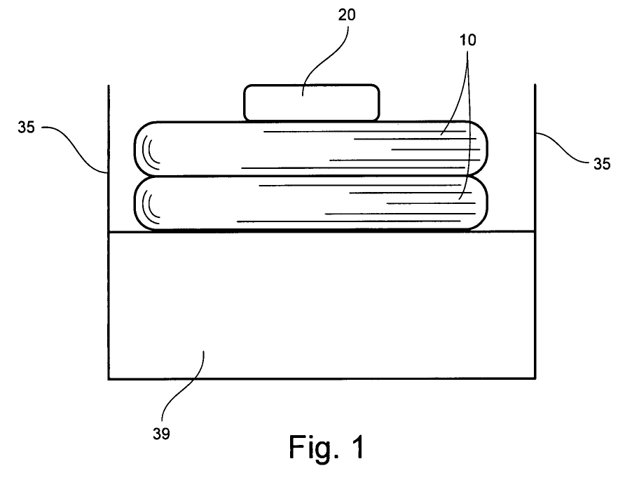

In some embodiments of the present invention, the food product 10 can be a griddle-type food product. As shown in FIG. 1, for example, the food product 10 can be pancakes. Alternatively, the food product 10 can be waffles, French toast, or other food products suitable for packaging for heating in a microwave oven for consumer use. In some embodiments, the food product 10 can be packaged, maintained, and provided to consumers in a or refrigerated condition. In other embodiments, a food product 10 other than a griddle-type food product can be packaged with a flow-capable topping 20. The flow-capable topping 20, for example, a butter and/or syrup topping, can hold its consistency such that it may not penetrate the food product 10 prior to heating in a microwave oven. For example, the butter-syrup topping can be packaged and maintained, at refrigerated temperatures, for example, in the range of 33-45 degrees Fahrenheit, or at room temperature, such that the topping does not penetrate the food product 10 prior to heating in a microwave oven. The food product 10 can be pre-cooked, or at least partially cooked, and or refrigerated, prior to packaging with the butter-based topping 20, syrup-based topping 20, or other topping 20 that is flowable when heated. The food product(s) 10 can be sufficiently pre-cooked or partially cooked so that the food product(s) 10 and flow-capable topping 20 are ready to eat when heated for a short time, for example, about one minute, in a microwave oven.

The food product 10 can be provided in a variety of forms or configurations. For example, in the particular embodiment shown in FIG. 1, the pancake food product 10 can be substantially round and partially flattened and have a diameter in the range of about 4-8 inches, or larger if desired. Alternatively, the pancake food product 10 can be smaller, for example, in the form of “mini-pancakes” having a diameter of about 2-3 inches. The food product 10 can have different shapes, such as oblong dipping sticks or cup-shaped shortcakes.

The pancake food product 10 can be made with different ingredients and/or have various textures. Pancakes 10 made with buttermilk and/or wheat flour are examples of the pancake food product 10 useful in some embodiments of the present invention. As an example, one embodiment of the pancake food product 10 can include enriched unbleached flour (wheat flour, malted barley flour, niacin, reduced iron, thiamine mononitrate, riboflavin, folic acid), water, corn syrup, partially hydrogenated soybean oil, buttermilk, sugar, eggs, salt, leavening (sodium bicarbonate, sodium acid pyrophosphate, monocalcium phosphate), and monoglycerides. One embodiment of the butter-syrup mix 20 can include cream, salt, and real maple syrup. The pancake food product 10 can have a variety of flavor profiles, including, for example, blueberry, strawberry, apple, cinnamon, and other flavors desirable in pancakes 10. Such flavor profiles can be provided by natural ingredients, such as bits of fruit, or by flavorings added to the food product 10. Other food products can be added to the primary food product 10. In one embodiment, pre-cooked sausage and/or bacon can be packaged with the pancake food product 10. Sausage can be packaged with another food product, such as the pancakes 10, in the form of separate links or patties, or can be mixed in as “bits” with the pancake food product 10.

In some embodiments of the present invention, the flow-capable topping 20 packaged with the food product 10 can be a butter-based topping 20. The butter-based topping 20 can comprise a mixture, or compound, of a butter component and a non-butter component. In certain embodiments, the butter component of the compound 20 can be 100% pure, fresh butter. That is, the compound 20 can be referred to as “made with real butter” and/or as a “butter spread.” In certain embodiments, the butter component can be non-dairy. The non-butter component can be a syrup component, for example. The syrup component may be a maple syrup component. In certain embodiments, the syrup component can be pure, natural syrup, such as natural, or “real,” maple syrup. The butter-based compound 20 can be heated, for example, in a microwave oven, with the co-packaged food product 10, such that the butter-based compound 20 can become flowable when heated the recommended period of time, for example, less than one minute. When heated in a microwave oven for the recommended period of time, the butter-based compound 20 can flow over and about the food product 10. Thus, particular embodiments of the present invention can include a microwavable food product 10, such as a griddle-type food product 10, packaged with a flow-capable topping 20 that includes pre-mixed, substantially pure butter and substantially all natural syrup ingredients.

In one illustrative embodiment, the butter-syrup compound 20 can comprise about 50% butter and about 50% maple syrup component. In certain embodiments, the maple syrup component can comprise about 80% natural maple syrup and about 20% of a mix of an imitation maple syrup and/or a maple seasoning powder. That is, the butter-syrup compound 20 can comprise about 50% pure, fresh butter, about 40% natural maple syrup, and about 10% of a mix of an imitation maple syrup and/or a maple seasoning powder.

Conventional commercial butter compounds often comprise about 80-90% butter and only less than about 10-20% non-butter components. Thus, as compared to conventional butter compounds, an embodiment of the butter-syrup compound 20 of the present invention can include a higher concentration of a non-butter component. A higher concentration of non-butter component, such as natural maple syrup, can provide a more natural (syrup) flavor profile relative to the butter-syrup compound 20. Thus, in some embodiments of the present invention, the butter-syrup compound 20 can include a higher relative concentration of maple syrup to provide a desirable syrup flavor profile, while maintaining the butter-syrup compound 20 in a solid consistency or form, that is, without separation of the butter and syrup components, or without the compound 20 penetrating into the food product 10. In certain embodiments, the highest optimal concentration of natural maple syrup in the butter-syrup compound 20 to maintain an unseparated solid compound may be about 50-60% by weight.

In some embodiments of the present invention, the butter-syrup compound 20 can comprise a homogenous mixture of butter and non-butter components. Homogeneity of the compound 20 mixture can help assure that the components maintain a consistency such that the individual components do not separate from each other or undesirably stick to a mold or a wrapping material, such as paper.

In some embodiments, the butter component can comprise “whipped” butter. Whipped, or aerated, butter can provide better mixing capabilities with the syrup component, melt more quickly than non-whipped butter, and increase the flowability of the butter-syrup compound 20. In addition, whipped butter can allow the use of less butter and thus may be more cost-effective than non-whipped butter.

In some embodiments, the non-butter component can include ingredients other than, or in addition to, a syrup component. For example, the non-butter ingredients may include natural and/or artificial flavorings to provide various flavor profiles for the butter-syrup compound 20. Examples of flavor profiles useful in an embodiment of a butter-syrup mix 20 of the present invention include strawberry, blueberry, maple, apple, and cinnamon, among others. In some embodiments, the non-butter component may include a starch or a modified starch, that can facilitate the agglomeration, or sticking together, of all of the components to enhance the homogeneity of the mixture and help maintain the compound 20 as an unseparated mixture, at least when in sold form. In some embodiments, the non-butter component of the butter-syrup mix 20 can include salt and/or cream as additives. When such other ingredients are included in the non-butter component, the concentration of the non-butter component in the butter-syrup compound may be greater than about 50-60% by weight.

The butter-syrup compound 20 can be flow-capable, that is meltable, or flowable, when exposed to, for example, microwave energy in a household microwave oven. When the compound 20 melts from solid consistency, or form, the butter component and the syrup component can separate slightly from each other. In such a separated condition, the butter may have a yellowish and slightly frothy appearance, while the syrup component may have a typical caramel-colored appearance of natural syrup. Thus, when the butter and syrup components melt from the initial solid consistency of the butter-syrup compound 20, the consumer can visualize both butter and syrup components, which may enhance the taste of the individual and/or combined flavors and the overall eating experience.

In some embodiments, the butter-syrup compound 20 can be packaged in direct contact with the food product 10. The butter-syrup compound 20 can be in the form of a solid, geometric configuration, such as a round or square portion of the compound 20, or another suitable configuration. The butter-syrup compound 20 can be molded into such a solid, geometric configuration. Such a molded configuration of the butter-syrup compound 20 can be referred to as a “pattie” or “pat.” A “pat” of the butter-syrup compound 20 can be packaged on top of a stack of individual food products 10, such as a stack of pancakes 10, or between individual pancakes 10 in a stack. Alternatively, a “pat” of the butter-syrup compound 20 can be packaged both on top of a stack of pancakes 10 and between individual pancakes 10 in the stack. In some embodiments, the butter-syrup compound 20 can maintain a solid consistency at various temperatures, for example, while, at refrigerated temperatures such as between 33 and 45 degrees Fahrenheit, or at room temperature. As a result, the compound 20 can be capable of not penetrating, or soaking into, the pancakes 10 prior to re-heating. Thus, some embodiments of the present invention can provide the microwavable food product 10 having the topping 20 packaged in direct contact with the food product 10 that may not penetrate the food product 10 prior to heating.

In alternative embodiments, the butter-syrup mix topping 20 can be packaged with the food product 10, such as pancakes 10, out of direct contact with the food product 10. For example, the topping 20 can be contained in a separate compartment in the package from the food product 10, or in a sealed container within the food product package.

The butter-based compound mixture 20 can be or refrigerated until use. For example, the butter-based compound 20 can be made and stored separately from the food product 10 until packaged with the food product 10 for sale to a consumer. Certain embodiments of the butter-syrup compound 20 include no preservatives. When at temperatures of about minus 10 degrees F., some embodiments of the compound 20 can have a shelf life of about one year.

In some embodiments of the present invention, the food product 10 can be packaged with the flow-capable topping 20 in a package suitable for microwaving. In an exemplary embodiment, the package can be made from a blank 30 comprising paper. The package can be constructed so as to contain the food product(s) 10, including the butter-syrup mix 20 after it is melted. Such a package construction can include a polymeric coating on the inside of the package. A polymeric coating can allow the package to be leak-proof and can help prevent the food product(s) 10 and/or topping 20 from absorbing into the package during storage, and particularly during heating in a microwave oven.

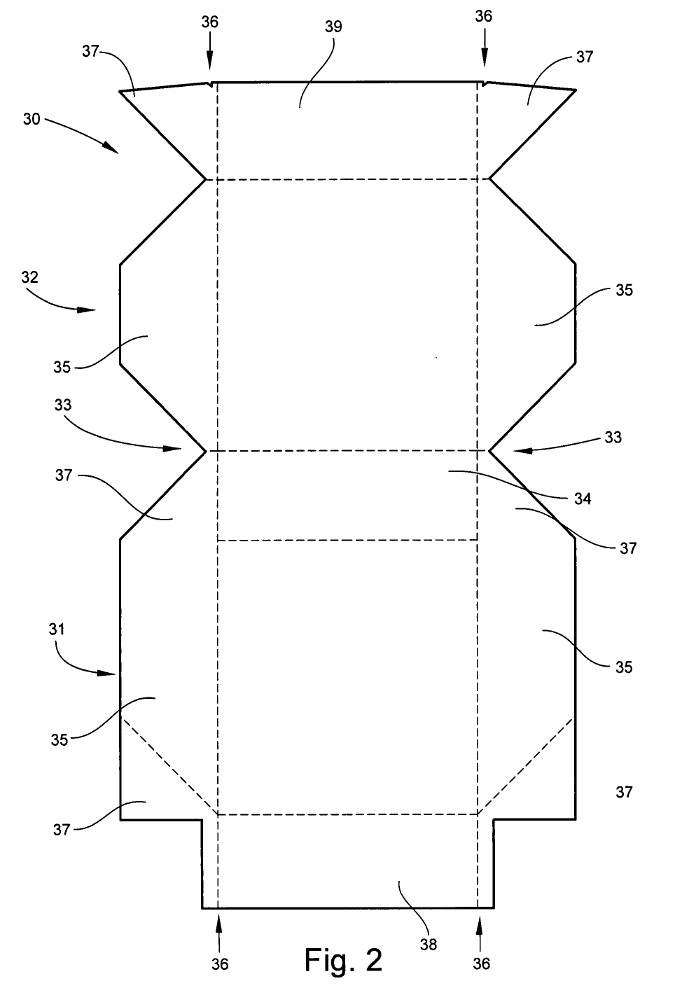

As shown in FIG. 2, such a package can be assembled from a package blank, for example, the package blank 30 known as a six-cornered “Beers” package with webbed corners. In the embodiment of the package blank 30 shown in FIG. 2, the top portion 31 and bottom portion 32 can be folded along two side-to-side fold lines 33 along the back flap 34 so that the back flap 34 forms a back wall of the package. Each set of the top and bottom side flaps 35 can be folded along one of two front-to-back fold lines 36 so that the side flaps 35 form two side walls of the package. Once the blank 30 is thusly folded to form the back wall and side walls, angled portions 37 on each side of the top front flap 38, the bottom front flap 39, and the back flap 34 can be overlapped with the side walls and secured to the side walls. The top front flap 38 can then be secured to the bottom front flap 39 to completely seal the package. The package may be assembled manually and/or in an automated fashion using package assembling equipment. The package assembled from the blank 30 shown in FIG. 2 can be a box having dimensions, for example, of 4 9/16 inches from front to back, 4 9/16 inches from side to side, and 1½ inches from top 31 to bottom 32 (deep). The food product 10 and topping 20 can be placed inside the package at various steps in the package formation process. The package can be easily opened by lifting the top front flap 38 away from the bottom front flap 39 either before or after heating the package and enclosed food product 10 and topping 20 in a microwave oven. Accordingly, an embodiment of the present invention can provide the food product 10 packaged with the flow-capable topping 20 in a microwavable package from which the food product 10 and topping 20 can be eaten by a consumer after heating.

The present invention can include other embodiments of a package. For example, certain embodiments of a package may include a cover (not shown), for example, a “top-seal” film, either in place of the top of the package, or tray, or underneath the top of the package/tray to further seal the food product 10 and topping 20 inside the package. In certain embodiments, the package can comprise a tray having a film sealing the top and/or sides of the package. For example, the food product 10 and topping 20 may be overwrapped with a plastic film, which can be sealed on each end and can include a “thin” seal between overlapping edges of the film for easy opening of the package. In other embodiments, the sealed tray can be inserted into an outer, or master, package, or sleeve. Alternatively, the food product 10 and topping 20 can be wrapped, for example, shrink-wrapped, within an inner wrapper and placed inside the package, and/or the entire exterior of the package can be shrink-wrapped. In another embodiment, at least a portion of the package can be transparent to provide a consumer a means for viewing the food product(s) 10 prior to purchase and/or during heating the package and food product(s) 10 in a microwave oven.

In yet another embodiment, the package can include at least two compartments (not shown) for containing various food products 10 in separate areas of the package out of contact with each other. For example, a doughnut-type dipping stick food product 10 can be placed in a first compartment and the butter-syrup mix 20 can be placed in a separate, second compartment. In this manner, when the package is sufficiently heated, the dipping sticks 10 can be picked up and dipped into the compartment containing the melted butter-syrup mix 20. In still another embodiment, the package can comprise a cup-shaped configuration (not shown). The package can be configured to fit into a cup holder in a vehicle. Such a package can include a lid of film sealed over the top opening of the cup-shaped package. In one exemplary embodiment, the present invention can include two pre-cooked pancakes 10 and two pats of the butter-syrup mix 20 comprising 100% pure, fresh butter and all natural, or “real,” maple syrup in a microwavable package. For embodiments comprising individual-sized serving portions, the total net weight of the pancakes 10 and butter-syrup mix 20 in such portions can be, for example, about 3.2 ounces for “mini-pancakes,” 4.0 ounces for two pancakes, and 5 ounces for pancakes and sausage. In one particular embodiment, the two pancakes 10 together can weigh about 2.8 ounces, and the two pats of butter-syrup mix 20 can weigh about 0.8 ounces. In other embodiments, the weights of each of the food product(s) 10 and the toppings 20 can vary. In certain embodiments, the package and food product(s) 10, 20 contained therein, may be heated in a microwave oven for less than about one minute to sufficiently warm the food products 10, 20 for readiness to eat. In other embodiments, the package and food product(s) 10, 20 may be heated in a microwave oven for more than about one minute to sufficiently warm the food products 10, 20 for readiness to eat. In embodiments comprising pancakes 10 and the butter-syrup mix topping 20 in direct contact with the pancakes 10, heating the package can cause the butter-syrup compound 20 to flow over and into the pancakes 10, while containing the butter and syrup in the package. In this manner, a consumer can quickly “heat and eat” a package of pancakes 10 having the butter-syrup mix 20 in the package and heated with the pancakes 10.

Embodiments of the present invention can be useful for providing microwavable food products 10 to consumers in various settings. For example, an embodiment of a microwavable package containing the food product 10 and the pre-mixed butter-syrup compound 20 can be provided in retail outlets, such as convenience stores, fast food restaurants, and grocery stores, as well as through vending machines. One embodiment of the present invention is currently available commercially as GoStax™ Buttermilk Pancakes from Cathead Foods™ in Morganton, N.C. Alternatively, an embodiment of the present invention can be provided for consumers in an institutional setting, for example, a cafeteria. An embodiment of the present invention useful for an institutional setting can include, for example, the food product(s) 10, such as pancakes 10 and the butter-syrup mix 20, in a plastic package, without an external box-type package, in which the food product(s) 10 can be heated and consumed.

Some embodiments of the present invention can include a method of making the microwavable food product 10 packaged with the flow-capable topping 20. In one such embodiment, a microwavable package, or container, can be assembled. Such a package may be assembled manually and/or in an automated fashion using equipment designed to assemble such packaging. The package may be suitable for storing and heating the food product 10 and flow-capable topping 20. Such a package can provide a means for containing the topping 20 after being heated so that the food product 10 and topping 20 can be consumed from the package.

In such a method, the food product 10 can be, for example, a serving of pre-cooked pancakes 10 or waffles. The food product 10 can have various flavor profiles, textures, and/or configurations. The food product 10 can be pre-cooked and then or refrigerated.

In some embodiments of a method, the flow-capable topping 20 can be manufactured separately from the food product 10, or refrigerated, and then packaged in direct contact with the food product 10. In certain embodiments, the flow-capable topping 20 can remain solid while frozen, at refrigerated temperatures, for example, in the range of 33 to 45 degrees Fahrenheit, or at room temperature. In particular embodiments, the topping 20 can be adapted to remain solid while in direct contact with the food product 10, or other food product(s), so as to not penetrate into the food product 10 prior to heating. The flow-capable topping 20 can be a butter-based topping. The butter-based topping can comprise a mixture, or compound, of a butter component and a non-butter component. The non-butter component can be maple syrup, for example. In certain embodiments, the butter-syrup compound 20 can comprise about 50% butter and about 50% maple syrup. The butter component can be pure, fresh butter. The syrup component can be real, natural syrup. The butter-syrup compound 20 can be in the form of a molded “pat” or another suitable configuration. In such a method, the food product(s) 10 and flow-capable topping 20 can be packaged in a microwavable package that can contain the food product(s) 10 and topping 20 after the topping is heated and flows. In this manner, a consumer can “heat and eat” the food product, such the pancakes 10, and topping, such as the butter-syrup mix 20, directly from the package in a convenient manner. Such a method can provide consumers with the advantage of having butter and syrup pre-mixed and applied to the pancakes 10 or other food product. Such a method can provide consumers with the advantage of a pre-packaged, microwavable pancakes 10 and topping 20 having the flavor profile of fresh butter and natural syrup.

Some embodiments of the present invention can include a method of using the microwavable food product(s) 10, 20. Such a method can include providing a combination of the food product 10 and the flow-capable topping 20, such as a butter-based topping, in a package, each of which is microwavable. The food product 10 may be, for example, pre-cooked pancakes 10 or waffles, and can have various flavor profiles, textures, and/or configurations. The butter-based topping 20 can comprise a mixture, or compound, of a butter component and a non-butter component. The non-butter component can be maple syrup, for example. The butter-syrup compound can comprise about 50% butter and about 50% maple syrup. The butter component can be pure, fresh butter, and the syrup component can be pure, natural syrup. The butter-syrup compound 20 can be packaged in direct contact with the food product 10 or not in direct contact with the food product 10. The butter-syrup compound 20 can remain solid while or at refrigerated temperatures, and may not penetrate into the food product 10 prior to heating. The package may be constructed so as to contain the food product(s) 10, including the butter-syrup mix 20, after it is heated.

After purchasing such a microwavable food product 10, the consumer may readily place the package into a microwave oven and heat the package for the recommended time, for example, less than about one minute. After removing the heated package from the microwave oven, the consumer can open the package and eat the food product 10 having the topping 20 dispersed about and into the food product 10 directly from the package. In such a method, a consumer can advantageously use the microwavable food product 10 having the convenience of the topping 20 packaged directly, in contact, with the food product 10 and that may not penetrate the food product 10 prior to heating. In such a method, a consumer can use the microwavable food product 10 packaged with the butter-syrup topping 20 that includes pure, fresh butter and natural syrup ingredients.

Although the present invention has been described with reference to particular embodiments, it should be recognized that these embodiments are merely illustrative of the principles of the present invention. Those of ordinary skill in the art will appreciate that embodiments of microwavable food products and methods of the present invention may be constructed and implemented in other ways. Accordingly, the description herein should not be read as limiting the present invention, as other embodiments also fall within the scope of the present invention.

What is claimed is:

1. A product, comprising:
a first food product in a package; and
a second food product in the package comprising a flow-capable butter-syrup compound adapted to remain solid prior to heating.

2. The product of claim 1, wherein the butter-syrup compound is packaged in direct contact with the first food product.

3. The product of claim 1, wherein each of the first and second food products is microwavable.

4. The product of claim 1, wherein the first food product comprises a pre-cooked or partially cooked food product.

5. The product of claim 1, wherein the first food product comprises a frozen or refrigerated food product.

6. The product of claim 1, wherein the first food product comprises a pancake.

7. The product of claim 1, wherein the butter-syrup compound comprises substantially pure butter.

8. The product of claim 1, wherein the butter-syrup compound comprises substantially all natural syrup.

9. The product of claim 1, wherein the butter-syrup compound comprises about 50% butter and about 50% maple syrup.

10. The product of claim 1, wherein the butter-syrup compound comprises about 50% pure butter, about 40% natural maple syrup, and about 10% of a mix of imitation maple syrup and maple seasoning.

11. The product of claim 1, wherein the butter-syrup compound comprises a concentration of natural maple syrup in the range of about 50 to 60%.

12. The product of claim 1, wherein the butter-syrup compound comprises a homogenous mixture of butter and syrup components.

13. The product of claim 1, wherein the butter-syrup compound comprises a solid, geometric configuration.

14. The product of claim 1, wherein the package is adapted to contain the first and second food products after the butter-syrup compound is caused to flow by heating with microwaves, whereby the first and second food products can be eaten directly from the package.

15. The product of claim 1, wherein the butter-syrup compound is adapted to flow over and into the first food product by heating the package with microwaves for about one minute or less.

16. The product of claim 1, wherein the package comprises a film of material sealed about at least a portion of the package.

17. The product of claim 1, the package comprising at least two compartments, and wherein the first food product is packaged in a first compartment and the second food product is packaged in a second compartment and without contact with the first food product.

18. A method, comprising:
packaging a first food product in a package; and
packaging a second food product in the package, the second food product comprising a flow-capable butter-syrup compound adapted to remain solid prior to heating.

19. The method of claim 18, further comprising packaging the butter-syrup compound in direct contact with the first food product.

20. The method of claim 18, the butter-syrup compound further comprising a butter component and a syrup component, the method further comprising providing the butter-syrup compound as a homogenous mixture of the butter and syrup components.

21. The method of claim 18, wherein the butter-syrup compound comprises substantially pure butter.

22. The method of claim 18, wherein the butter-syrup compound comprises substantially all natural syrup.

23. The method of claim 18, wherein the butter-syrup compound comprises about 50% butter and about 50% maple syrup.

24. The method of claim 18, wherein the package is adapted to contain the first and second food products after the butter-syrup compound is caused to flow by heating with microwaves, the method further comprising heating the package with microwaves and eating the first and second food products directly from the package.
